(19) United States
(12) Patent Application Publication
(10) Pub. No.: US 2011/0239827 A1
(43) Pub. Date: Oct. 6, 2011

(54) MULTIPLE SOCKET RATCHET WRENCH

(75) Inventor: Don Hart, Dana Point, CA (US)

(73) Assignee: ALLTRADE TOOLS LLC, Long Beach, CA (US)

(21) Appl. No.: 12/750,406

(22) Filed: Mar. 30, 2010

(51) Int. Cl. B25B 13/46; B25B 13/06; B25B 23/16

(52) U.S. Cl. 81/60; 81/124.5; 81/124.3; 81/125.1

(57) ABSTRACT

A multiple socket ratcheting wrench is described comprising an elongate handle with a first end and a second end. A first mounting element connected to the first end and a second mounting element connected to the second end. A first holder element rotatably attached by a first pin to the first mounting element is provided, wherein the first holder is capable of rotating at least 180 degrees about the first pin, the first holder element defining a first opening and a second opening. The first opening receives a first socket and a second socket, and the second opening receives a third socket and a fourth socket. A first ratcheting means is attached to the first holder element and is configured to control torque direction of the first socket and the second socket, and a second ratcheting means is attached to the first holder element and is configured to control torque direction of the third socket and the fourth socket.

### BACKGROUND

This application relates to ratcheting wrenches. Specifically, the application relates to ratcheting wrenches that are capable of presenting the user with a choice of multiple different sizes of ratchet socket.

Wrenches are known in the art. Recently, ratcheting wrenches have been introduced into the art that permit a user to place a ratchet socket over a bolt head and rotate the handle of the wrench in a first direction to tighten (or loosen) the bolt head, and thereafter to rotate the handle in an opposite second direction without loosening (or tightening) the head in the process of the second rotation. Such ratcheting wrenches are extremely useful because they allow a user to rapidly install or remove a bolt without having to lift the socket off the head each time he wishes to reverse the direction of rotation of the handle, and then installing the socket on the head again after each reversal. This feature gives the user considerable time saving.

However, there are shortcomings in the prior art. Each time a user wishes to exchange a first socket that he has been using on a first bolt head of a first size, for a second socket for using on a second bolt head of a second different size, the user is obliged to put down the first ratchet, search his work area for a second ratchet, and install the second ratchet on the second bolt. This is a time consuming process which is often further delayed when the second ratchet is misplaced in a busy work area.

Therefore there is a need in the art for a solution to the problems stated above. The present invention addresses these and other needs.

### SUMMARY OF THE INVENTION

In a preferred embodiment, a multiple socket ratcheting wrench is described comprising an elongate handle with a first end and a second end. A first mounting element is connected to the first end. A first holder element is rotatably attached by a first pin to the first mounting element wherein the first holder element is capable of rotating at least 180 degrees about the first pin. The first holder element defines a first opening and a second opening wherein the first opening receives a first socket and a second socket. The second opening receives a third socket and a fourth socket. Each socket is differently sized from the other sockets. Further, the preferred embodiment includes a first ratcheting means attached to the first holder element and is configured to control torque direction of the first socket and the second socket. A second ratcheting means is attached to the first holder element and is configured to control torque direction of the third socket and the fourth socket.

In preferred aspects of the invention, the first socket and the second socket are rotationally connected to each other in a single tube, and the third socket and the fourth socket are rotationally connected to each other in a single tube. In another preferred aspect, the first holder is capable of rotating more than 360 degrees about the first pin. Also preferred, the first pin includes a detent means and the first mounting element includes a mating detent means, whereby rotation of the holder element about the first pin is capable of being restrained.

In further aspects of the invention, the wrench includes a second mounting element connected to the second end, and a second holder element rotatably attached by a second pin to the second mounting element. The second holder is capable of rotating at least 180 degrees about the second pin, and the second holder element defines a third opening and a fourth opening wherein the third opening receives a fifth socket and a sixth socket, and the fourth opening receives a seventh socket and an eighth socket. Each socket is sized differently from all the other sockets in the wrench. A third ratcheting means is attached to the second holder element and is configured to control torque direction of the fifth socket and the sixth socket, and a fourth ratcheting means is attached to the second holder element and is configured to control torque direction of the seventh socket and the eighth socket.

These and other aspects of the invention will be better understood with reference to the drawings and the detailed description of the preferred embodiments.

### BRIEF DESCRIPTION OF THE DRAWINGS

FIG. 1 is a perspective view of a multiple socket ratchet wrench having features of the present invention, shown in a first condition.

FIG. 2 is a top view of the ratchet wrench shown in FIG. 1.

FIG. 3 is a side view of the ratchet wrench shown in FIG. 1.

FIG. 4 is a perspective view of the ratchet wrench shown in FIG. 1, shown in a second condition.

FIG. 5 is a perspective view showing components of the wrench of FIG. 1.

FIG. 6 is perspective view showing components of the wrench of FIG. 1.

### DETAILED DESCRIPTION OF THE PREFERRED EMBODIMENTS

A preferred embodiment of the invention is described in conjunction with the figures, which are shown for exemplification and not limitation. A preferred embodiment of the multiple socket ratchet wrench is generally identified in the figures by the numeral 10. The wrench 10 has an elongate handle 12 by which the wrench may be grasped and a turning force applied to the wrench. The handle has opposing ends. A first end of the handle is tipped with a first mounting element 14, and the opposite second end is tipped with a second mounting element 16. In a preferred embodiment, each mounting element comprises two opposing digit elements that are separated from each other, and that protrude away from the handle 12. Thus, the first mounting element 14 has two opposing digits 52, 54, and the second mounting element 16 has two opposing digits 56, 58.

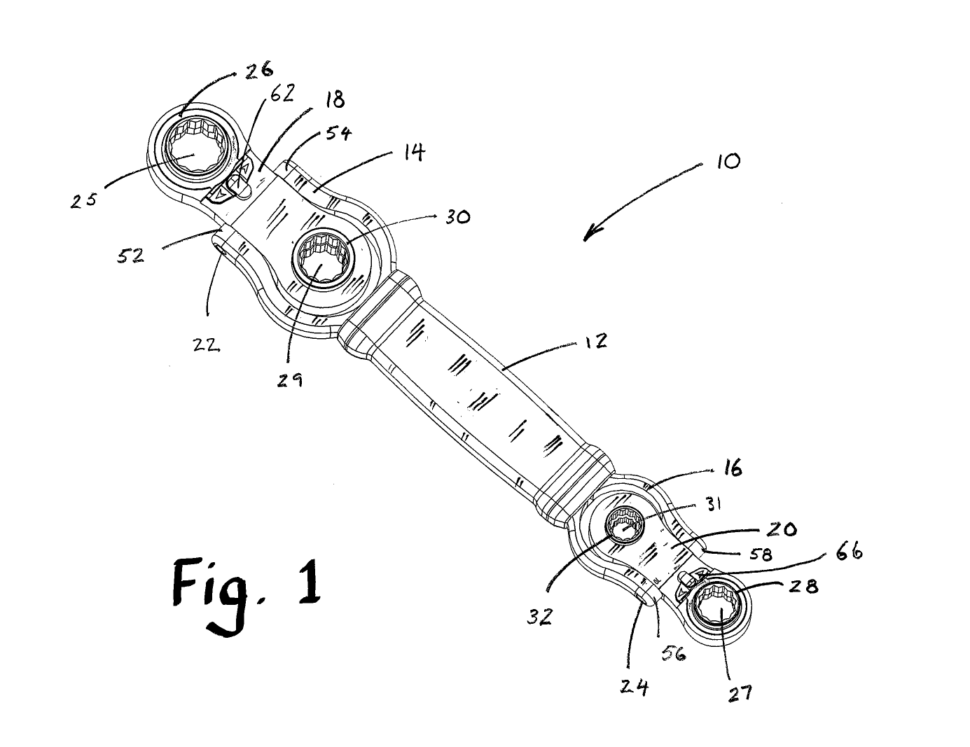

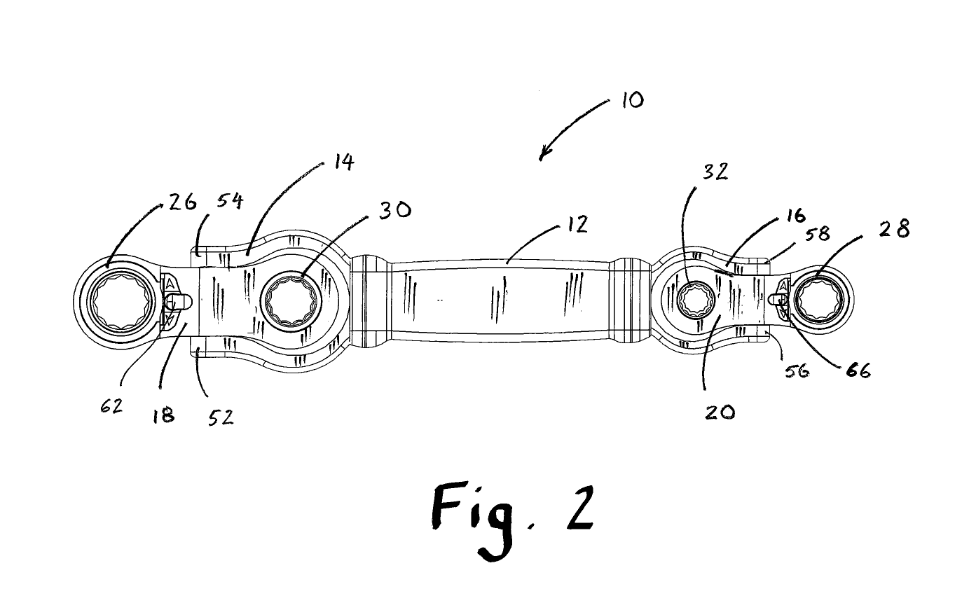

Between each set of digit elements of the two mounting members, a holder element is positioned, as best seen in FIGS. 1 and 2. Thus, a first holder element 18 is positioned between opposing digit elements 52, 54 of the first mounting element 14, and a second holder element 20 is positioned between opposing digit elements 56, 58 of the second mounting element 16. A first pin 22 passes through digit elements 52, 54 and to support the first holder element 18 so that the first holder element is able to rotate without restraint about the first pin 22. A second pin 24 passes through digit elements 56, 58 to support the second holder element 20 so that the second holder element is able to rotate without restraint about the second pin 24.

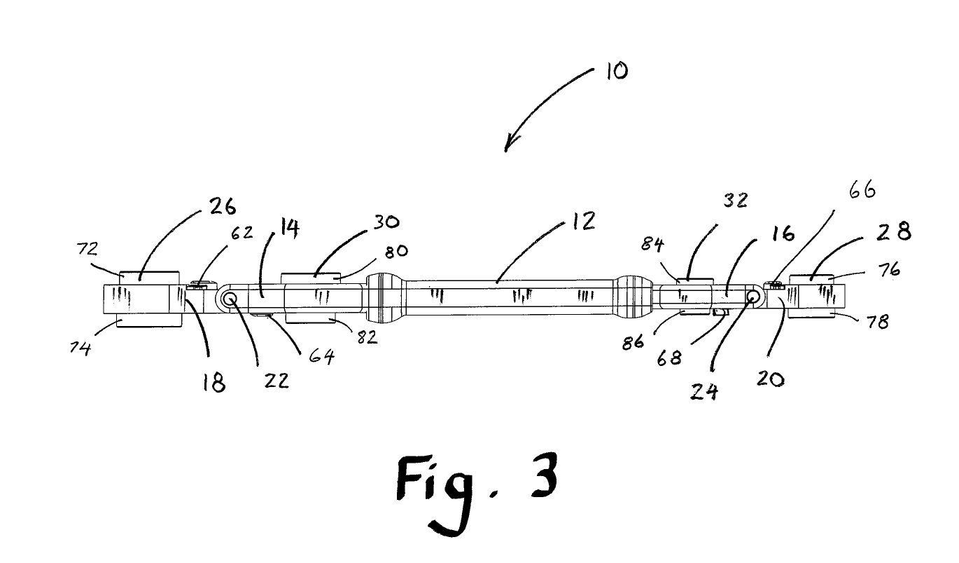

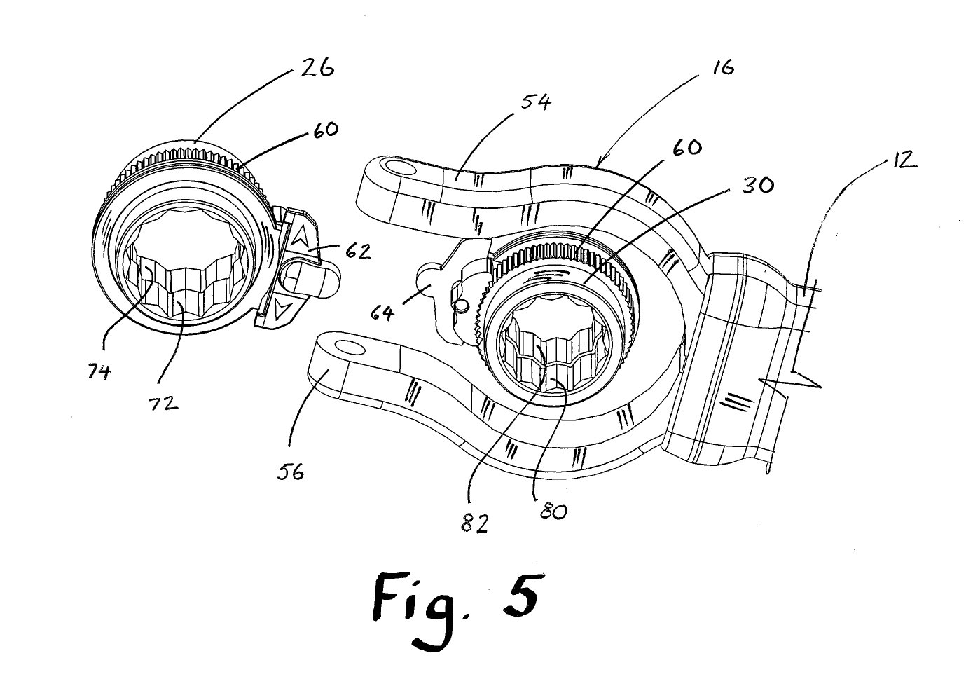

Each holder element has two circular openings. Thus, first holder element has two openings 25, 29, and second holder element has two openings 27, 32. Each of the four openings receives a rotatable cylindrical tube so that first holder element has rotatable cylindrical tubes 26, 30, and second holder element has cylindrical tubes 28, 32 received within their respective openings. Each cylindrical tube is fitted with a differently sized socket, a first socket presented at one side of the tube, and a second socket presented at the opposite side of the tube. Because there are four tubes, the described configuration permits eight differently sized sockets to be positioned on the wrench, two in each of the four tubes. Thus, first tube 26 has sockets 70, 72, second tube 30 has sockets 74, 76, third tube 28 has sockets 78, 80, and fourth tube 32 has sockets 82, 84 (FIG. 3)—each socket being differently sized from the other. This aspect is best seen and understood with reference to FIG. 5.

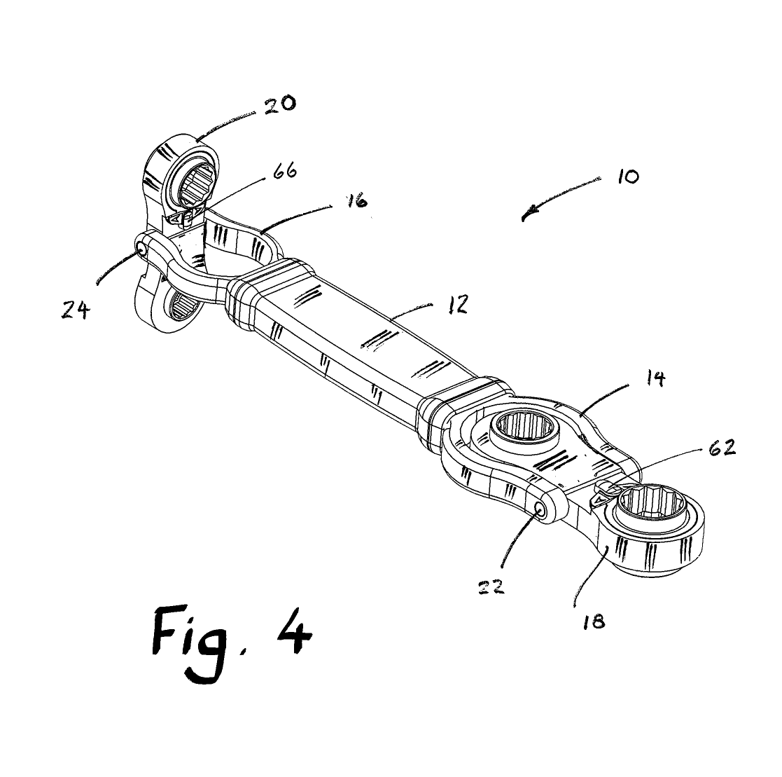

An advantageous feature of the invention arises by virtue of the rotatable holder elements 18, 20. If a user wishes to use one of the sockets that are not positioned at the end of the wrench, but that are positioned adjacent the handle 12, the user may simply rotate the appropriate holder element 180 degrees about the appropriate pin 22 or 24. FIG. 4 shows holder element 20 in the process of being rotated 180 degrees. As seen in FIG. 4, the holder element 20 has been rotated half way to its new condition, or 90 degrees. This action will place the required socket at an end of the wrench where it may be used more conveniently. The user may be required to turn the wrench over, so that the desired socket in the tube is presented to the bolt head.

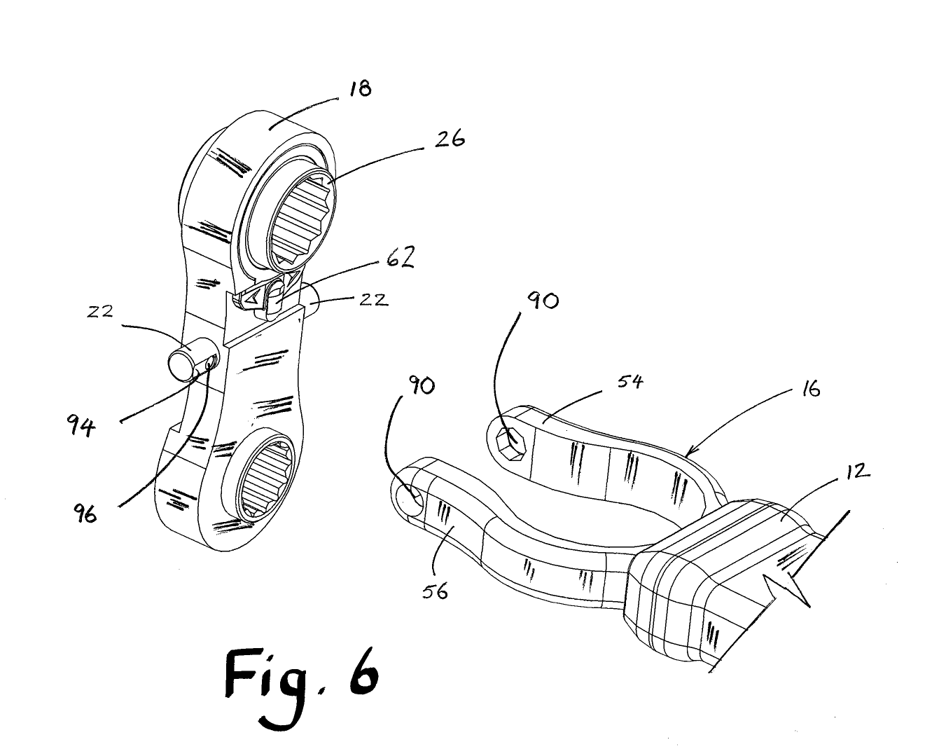

Detent mechanisms may be provided to restrain the rotation of the holder elements. In a preferred embodiment, exemplified in FIG. 6, it is shown that the first holder element 18 is supported by pin element 22. Pin element 22 rests in holes 90 that are cut into the digits 54 and 56 of the holder element 16 Internal portions of the holes 90 may be given a polygonal shape as seen in FIG. 6. The pin element 22 may be given a flat surface 94, into which a recess is cut, and a ball 96 positioned in the recess. A spring (not shown) may be positioned in the recess behind the ball to urge the ball outwardly. As the holder element 18 is rotated about the pin 22, the ball catches against each face of the polygonal hole 90, and retards the rotation at each face. Thus, a user may rotate the holder element by incremental amounts, and fix the holder against further rotation by snapping the pin detent and mating hole detent into registration. This provides a convenient number of angular settings for the holder member, including a position that places it in line with the handle 12, which is the most convenient for using the socket and ratchet capability of the wrench. Each holder element may be provided with a similar detent mechanism.

As to the ratcheting feature of the wrench, the invention employs conventional technology. Each tube (bearing two sockets per tube) is configured, on an exterior surface to have a plurality of teeth 60, as exemplified in FIG. 5. Each tube is positioned adjacent a conventional ratcheting means configured to engage with the teeth and thus to allow a forward drive torque to be imparted to the tube in one direction but not in the opposite or reverse direction. Thus, first tube 26 is associated with and operated by ratcheting means 62, second tube 30 by ratcheting means 64, third tube 28 by ratcheting means 66, and fourth tube 32 by ratcheting means 68 as seen in FIG. 3. By altering the setting of a switch that is part of the ratcheting means, the drive direction may be altered so that torque may be applied in a reverse direction but not a forward direction. Alternatively, the switch may be set so that drive torque may be imparted in both directions. Thus, each tube has its own ratcheting means, so that there are four separate ratcheting means on each wrench of the present invention.

Thus there has been described a novel and useful innovation in the art of ratchet wrenches, whereby an artisan may possess just one wrench in his toolbox, that is nevertheless capable of applying ratcheting torque to eight differently sized bolt heads.

Thus, the present invention addresses with novel and useful features certain needs that are found in the art. The present invention may, of course, be carried out in other specific ways than those herein set forth without departing from the essential characteristics of the invention. The present embodiments are, therefore, to be considered in all respects as illustrative and not restrictive, while the scope of the invention is set forth in the claims that follow.

I claim:

1. A multiple socket ratcheting wrench comprising:
an elongate handle with a first end and a second end;
a first mounting element connected to the first end; and
a first holder element rotatably attached by a first pin to the first mounting element wherein the first holder element is capable of rotating at least 180 degrees about the first pin, the first holder element defining a first opening and a second opening wherein the first opening receives a first socket and a second socket, and the second opening receives a third socket and a fourth socket, each socket being differently sized from the other sockets, and further wherein a first ratcheting means is attached to the first holder element and is configured to control torque direction of the first socket and the second socket, and a second ratcheting means is attached to the first holder element and is configured to control torque direction of the third socket and the fourth socket.

2. The wrench of claim 1, wherein the first socket and the second socket are rotationally connected to each other in a single tube.

3. The wrench of claim 2, wherein the third socket and the fourth socket are rotationally connected to each other in a single tube.

4. The wrench of claim 1, wherein the first holder is capable of rotating more than 360 degrees about the first pin.

5. The wrench of claim 1, wherein the first pin includes a detent means and the first mounting element includes a mating detent means, whereby rotation of the holder element about the first pin is capable of being restrained.

6. The wrench of claim 1, further including a second mounting element connected to the second end, and a second holder element rotatably attached by a second pin to the second mounting element wherein the second holder is capable of rotating at least 180 degrees about the second pin, the second holder element defining a third opening and a fourth opening wherein the third opening receives a fifth socket and a sixth socket, and the fourth opening receives a seventh socket and an eighth socket, each socket being sized differently from the other sockets, and further wherein a third ratcheting means is attached to the second holder element and is configured to control torque direction of the fifth socket and the sixth socket, and a fourth ratcheting means is attached to the second holder element and is configured to control torque direction of the seventh socket and the eighth socket.

7. The wrench of claim 6, wherein the fifth socket and the sixth socket are rotationally connected to each other in a single tube.

8. The wrench of claim 7, wherein the first seventh socket and the eighth socket are rotationally connected to each other in a single tube.

9. The wrench of claim 7, wherein the first holder is capable of rotating more than 360 degrees about the second pin.

10. The wrench of claim 6, wherein the second pin includes a detent means and the second mounting element includes a mating detent means, whereby rotation of the holder element about the second pin is capable of being restrained.
